(19) United States
(12) Patent Application Publication
(10) Pub. No.: US 2003/0110517 A1
(43) Pub. Date: Jun. 12, 2003

(54) Method and apparatus for displaying banners on a TV screen

(75) Inventor: Cary Lee, Taipei Hsien (TW)

Correspondence Address: BACON & THOMAS, PLLC, 625 SLATERS LANE, FOURTH FLOOR, ALEXANDRIA, VA, 22314

(73) Assignee: Kinpo Electronics, Inc., Taipei (TW)

(21) Appl. No.: 10/087,861

(22) Filed: Mar. 5, 2002

(30) Foreign Application Priority Data
Dec. 12, 2001 (TW) 90130815

(51) Int. Cl. H04N 7/16; H04N 5/445; H04N 7/173

(52) U.S. Cl. 725/139; 725/38; 725/40; 725/131; 725/151

(57) ABSTRACT

A method and apparatus for displaying banners on a TV screen is disclosed, which is used in a set-top box connected to a TV set, and the set-top box connects to the network to receive banner information to allow a TV screen to display images carrying the banner information. Therefore, information appliances (IA), such as the set-top box, can profit by displaying banner information on a TV screen bringing set-top box costs down.

### BACKGROUND OF THE INVENTION

1. Field of the Invention

The present invention relates to a method and apparatus for displaying banners on a TV screen and, more particularly, to a set-top box, and the method used in the set-top box for displaying banners on the TV screen.

2. Description of Related Art

Currently, set-top boxes are used with TV sets. Users can use a set-top box to receive the network signal (e.g. signal from internet) through the network interface of the set-top box, receive the TV signal over the tuner of the set-top box, and receive the video or CD-ROM drive signal over the AV terminal of the set-top box. Therefore, users can selectively switch to the TV-mode for watching TV programs, to the network-mode for connecting to the network, or to the AV-mode for watching videos or VCDs. Since the set-top box has computer capabilities, users can directly connect to a network via the set-top box without using a computer. Thus it is also good for promoting information appliances (IA). However, the conventional set-top box is only applied to the process of switching signals among the network signals, the TV signals, or other image signals. System providers or distributors cannot transmit any information, such as advertisements, to customers over set-top boxes to receive profit from advertisement. Therefore, the price of a set-top box is still too high to become popular.

Therefore, it is desirable to provide a method and apparatus for displaying banners on a TV screen that mitigates the aforesaid problems.

### SUMMARY OF THE INVENTION

The object of the present invention is to provide a method and apparatus for displaying banners on a TV screen so that users can use the set-top box not only for connecting to networks but also for receiving banner information while watching TV programs, videos, or VCDs. By displaying banner information on a TV screen to receive profit, System providers or distributors can reduce the cost of the set-top box to benefit users and facilitate the promotion of the set-top box.

To achieve the object, the method for displaying banners on a TV screen of the present invention comprises the steps of:

(A) receiving at least a TV-transmitted image signal, a video-transmitted image signal, or a CD (e.g. VCD, DVD) drive-transmitted image signal;

(B) processing the image signal to obtain a size-reduced image signal so that the size-reduced image signal displayed on the TV screen is reduced in size, and positioning the size-reduced image signal on the TV screen;

(C) receiving the banner information via the network;

(D) processing the banner information to obtain a banner image signal, and positioning the banner image signal on the TV screen; and

(E) outputting the size-reduced image signal and the banner image signal to the TV set.

Other objects, advantages, and novel features of the invention will become more apparent from the following detailed description when taken in conjunction with the accompanying drawings.

### BRIEF DESCRIPTION OF THE DRAWINGS

FIG. 1 is a schematic drawing according to the present invention.

FIG. 2 is a block diagram showing the hardware architecture of a set-top box according to the present invention.

FIG. 3 is a schematic drawing showing programs stored in a memory device according to the present invention.

FIG. 4 is a flow chart of the steps required for a set-top box to display banners on a TV screen according to the present invention.

FIG. 5 is a schematic drawing showing banner image signals displayed on a TV screen according to the present invention.

FIG. 6 is a flow chart illustrating a banner-processing program according to the present invention.

### DETAILED DESCRIPTION OF THE PREFERRED EMBODIMENT

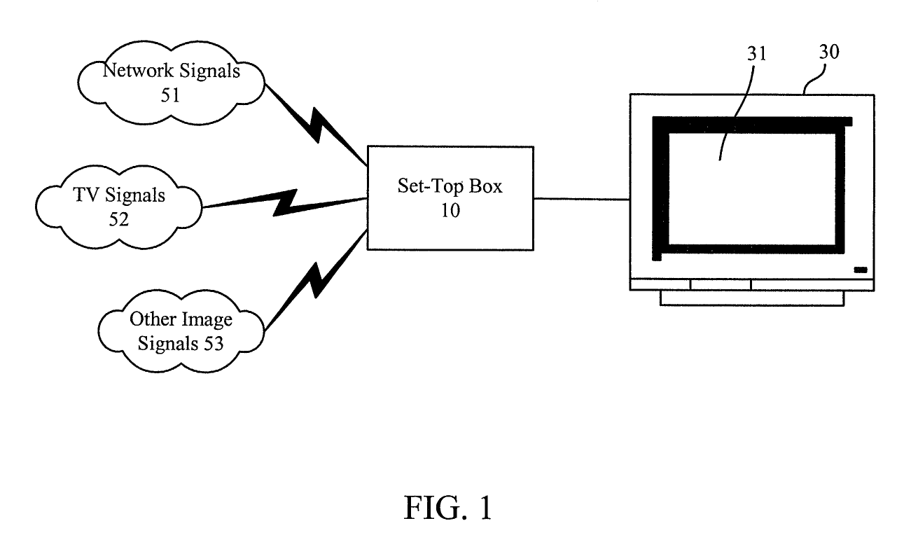

With reference to FIG. 1, there is shown a schematic drawing according to the present invention. The set-top box 10 is coupled to a TV set 30. The set-top box 10 can receive the network signals 51, the TV signals 52, or other image signals 53 transmitted by an image device coupled to the TV set 30. The image device could be a video, a CD-ROM drive, a DVD player, or other image devices without departing from the scope and spirit of the invention. Therefore, users can use the TV set 30 to watch TV programs, connect to the network (e.g. internet) to surf websites, or watch other image programs provided by other image devices.

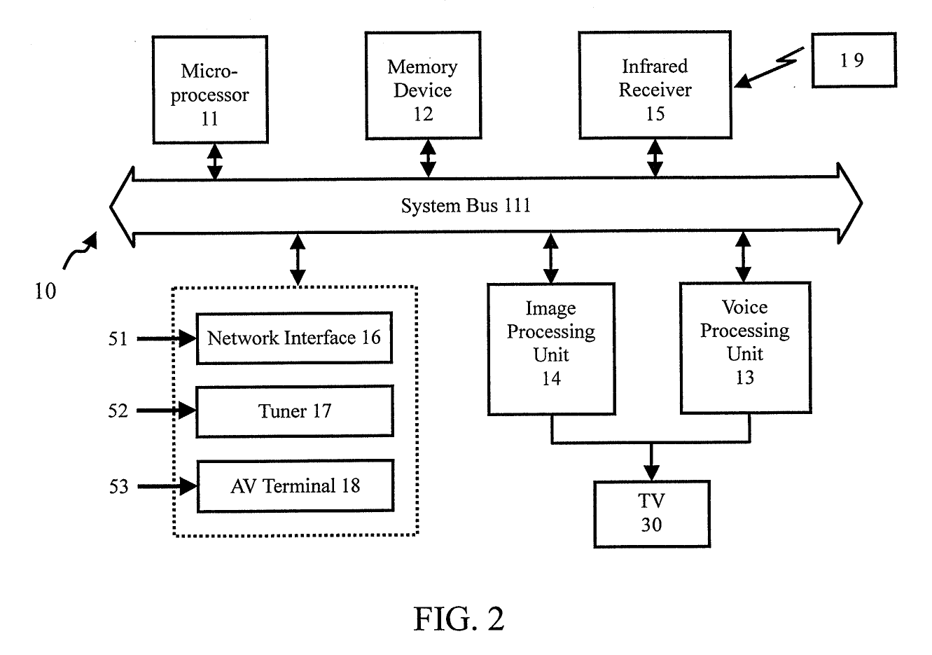

The hardware architecture of the aforesaid set-top box 10 is shown in FIG. 2. Similar to the hardware architecture of a personal computer, the set-top box 10 comprises a microprocessor 11, a system bus 111, a memory device 12 (for example, a hard disk drive, or a memory interface card), a voice-processing unit 13, and an image-processing unit 14. A person skilled in the art can easily achieve this hardware architecture, so the details of hardware are not disclosed hereinafter. The hardware architecture of the set-top box 10 is similar to a personal computer with the exception of having an infrared receiver 15, a network interface 16, a tuner 17, an AV terminal 18, and an input device 19 (for example, a remote controller). The network interface 16 can receive the network signals 51 (for example, the signal transmitted via the internet); the tuner 17 can receive the TV signals 52; the AV terminal 18 can receive other image signals 53 such as signals from the video or the CD-ROM drive.

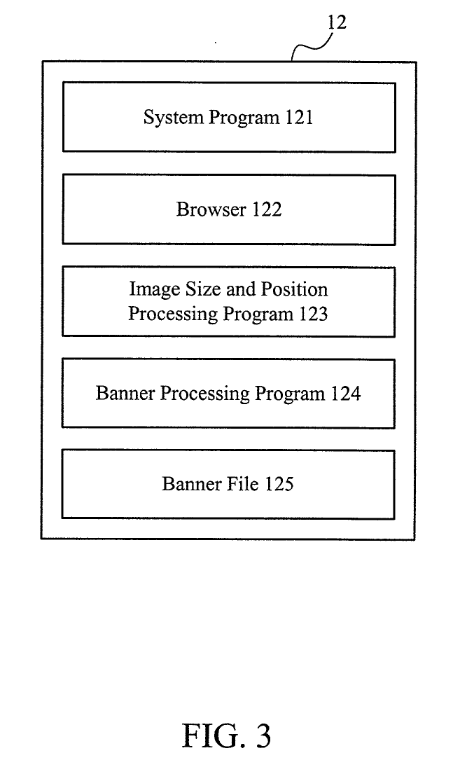

The software programs stored in the memory device 12 of the present invention is outlined hereinafter with reference to FIG. 3. Similar to the hardware architecture of a personal computer, the memory device 12 of the set-top box 10 basically comprises a system program 121, and a browser 122. However the memory device 12 further comprises an image size and position processing program 123, a banner processing program 124, and a banner file 125. The function of the programs or files described above specially designed for the present invention will be mentioned in detail hereafter.

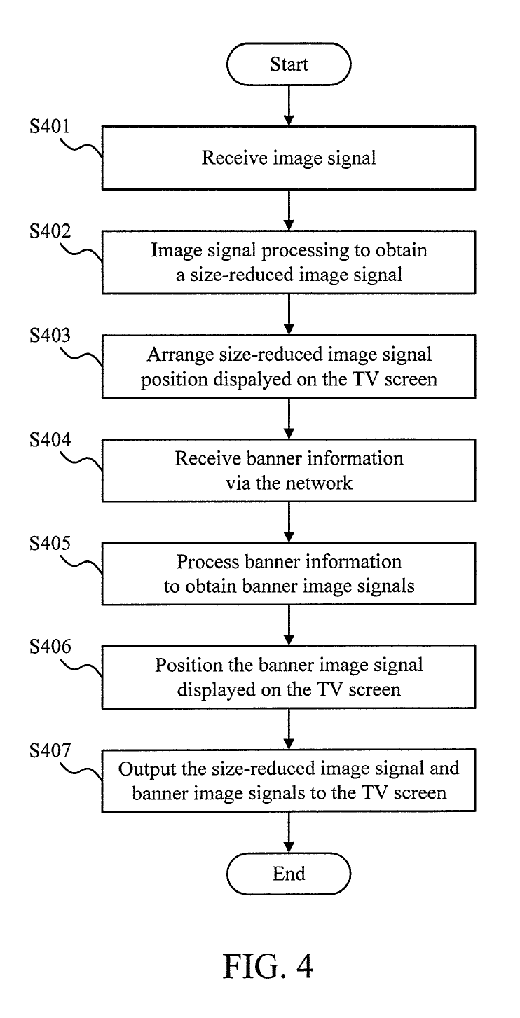

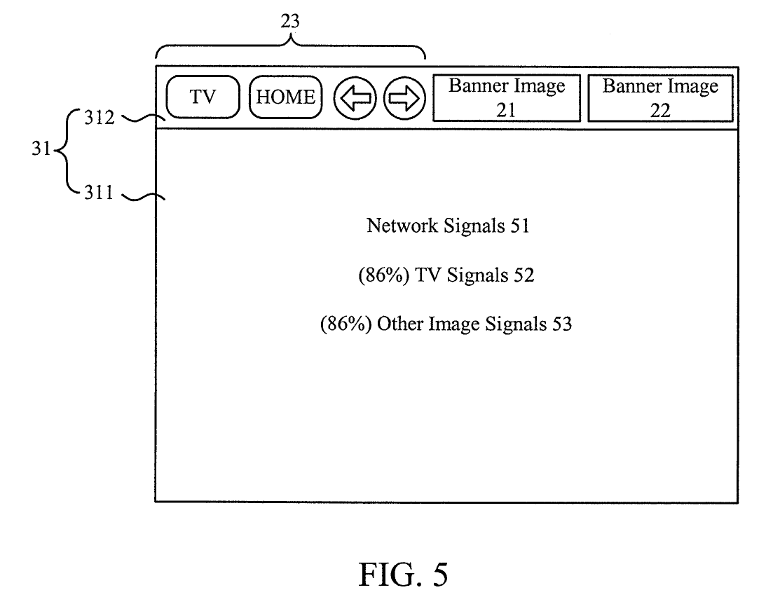

The set-top box 10 of the present invention connects to the network for receiving banner information so the TV screen 31 displays images carrying banner information. FIG. 4 is a flow chart of the steps required for the set-top box 10 to display banners on the TV screen 31. At the beginning, the set-top box 10 receives the image signal (S401). The image signal may comprise a TV-transmitted image signal, a video-transmitted image signal, a CD (e.g. VCD, DVD) drive-transmitted image signal, or the like. Because the TV screen 31 can display banners, the window of the TV screen 31 is divided into two parts as shown in FIG. 5. One is the image signal window 311 for displaying image signals or network signals 51, and the other is the banner image signal window 312 for displaying banner image signals 21 and 22.

In order to display image signals received in step S401 on the image signal window 311, the set-top box 10 has to process the image signal to obtain a size-reduced image signal (S402) so that the size-reduced image signal displayed on the TV screen 31 is reduced in size. And then the set-top box 10 arranges the position of the size-reduced image signal on the image signal window 311 (S403). As described above, steps S402 and S403 are executed by the image size and position-processing program 123 mentioned in FIG. 3.

The set-top box 10 can also receive the network signals 51 in step S401. However, the network signals 51 do not need to be processed to obtain a size-reduced network signal in step S402 because the network signals 51 can be displayed on the TV screen 31 without being influenced by the size of the window of the TV screen 31. And then the set-top box 10 arranges the position of the network signals 51 displayed on the image signal window 311 as described in the step S403.

The set-top box 10 receives banner information via the network (S404), wherein the URL (Universal Resource Locator) for obtaining banner information has been predetermined by the set-top box 10. Therefore, the set-top box 10 can directly hyperlink to the server according to the IP address of the URL to receive banner information, and then saves the banner information in the banner file 125 mentioned in FIG. 3. At this time, the set-top box 10 processes banner information to obtain banner image signals 21 and 22 (S405), and positions the banner image signals 21 and 22 displayed on the TV screen 31 (S406). The banner image signals 21 and 22 are positioned in the banner image signal window 312. Steps S405 and S406 are processed by the banner processing program 124 mentioned in FIG. 3. After processing image signal and banner information, the set-top box 10 outputs the size-reduced image signal to the image signal window 311 and banner image signals 21 and 22 to the banner image signal window 312 respectively (S407).

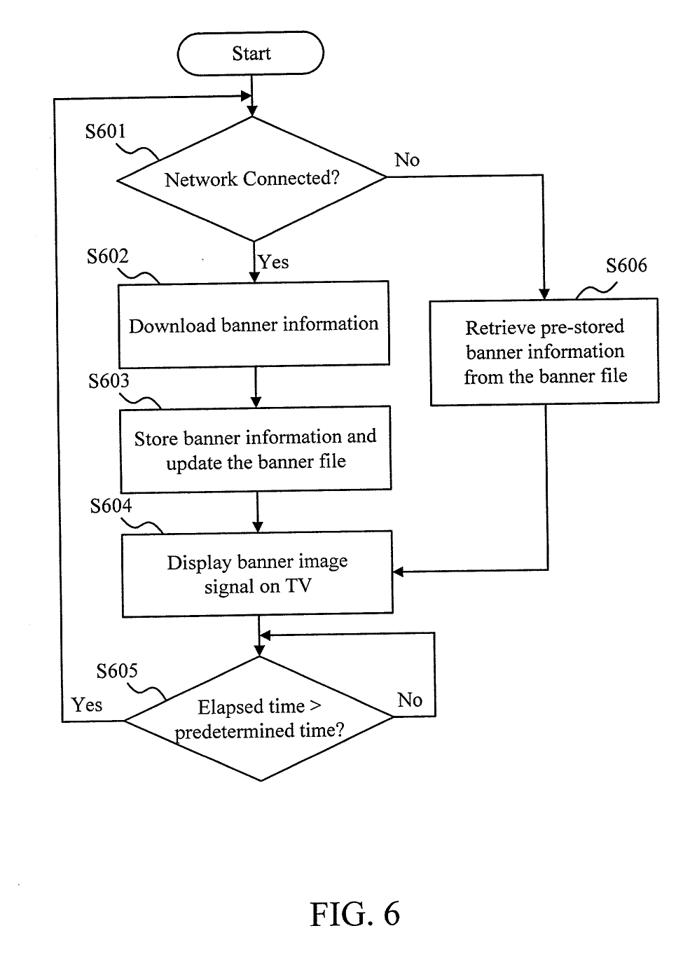

With reference to FIG. 6, there is shown a detailed flow chart illustrating the banner-processing program 124. The situation disclosed in FIG. 4 assumes that the network is connected. However, in reality users may turn on the TV set 30 at first without connecting to the network, or the network fails to connect. So the set-top box 10 has to determine whether the network is initially connected (S601). If the network is successfully connected, the set-top box 10 can download banner information via the network (S602). After downloading banner information, the set-top box 10 stores banner information in the banner file 125 to update the banner file 125 (S603). Further, the set-top box 10 can retrieve the updated banner information from the banner file 125 and process the banner information to produce banner image signals 21 and 22, and then display banner image signals 21 and 22 on the banner image signal window 312 (S604). Since banner information provided by advertisers would be continuously updated, the set-top box 10 updates banner information after a predetermined elapsed time. The predetermined elapsed time can be one or two hours, or it can be counted in minutes or seconds. When the predetermined elapsed time exceeds the predetermined time (S605), the set-top box 10 will execute the procedure from step S601 to step S605, and the elapsed time is set to zero upon completion of step S605. In step S601, if the network is not connected, the set-top box 10 could retrieve and receive the previously stored banner information from the banner file 125 (S606). So the set-top box 10 processes the pre-stored banner information stored in the banner file 125 and continuously checks the network condition. After the network is connected, the set-top box 10 can update the banner file 125.

With reference to FIG. 5, there is shown a schematic drawing showing banner image signals 21 and 22 displayed on the TV screen 31. In this embodiment, the size of the image signal window 311 is reduced to 86 percent of the full TV screen 31. So the TV signals 52 or other image signals 53 displayed on the image signal window 311 are reduced to 86 percent of its original size, and the network signals 51 displayed on the image signal window 311 are 100 percent of its original size. In addition, the size of the image signal window 311 is not limited as described above.

In this preferred embodiment, the TV screen 31 is divided into two parts, one is on the top side of the TV screen 31 called the banner image signal window 312, and the other is on the bottom side of the TV screen 31 called the image signal window 311. Of course the arrangement of the image signal window 311 and the banner image signal window 312 shown on the TV screen 31 are not limited as described above. They can be changed such as the image signal window 311 can appear on the left side of the TV screen 31, and the banner image signal window 312 can appear on the right hand side of the TV screen 31, or the like. In addition to banner images 21 and 22, the banner image signal window 312 further comprises a tool bar 23 enabling users to switch to TV-mode, hyperlink to their home page, browse the previous or next page, or choose other functions designed for satisfying the needs of users. The banner image signals window 312 comprises not only two banner image signals, wherein banner image signals could be GIF, JPG, JPEG, or BMP files. Banner image signals also comprise the URL path for users to hyperlink to the website of the advertiser.

Although the present invention has been explained in relation to its preferred embodiment, it is to be understood that many other possible modifications and variations can be made without departing from the spirit and scope of the invention as hereinafter claimed.

What is claimed is:

1. A method for displaying banners on a TV screen, used in a set-top box connected to a TV set, wherein the set-top box connects to the network for receiving a banner information to let a TV screen display images carrying the banner information, the method comprising the steps of:
(A) receiving at least one image signal selected from the group consisting of a TV-transmitted image signal, a video-transmitted image signal, or a compact disk drive-transmitted image signal;
(B) processing the image signal to obtain a size-reduced image signal so that the size-reduced image signal displayed on the TV screen is reduced in size, and positioning the size-reduced image signal on the TV screen;
(C) receiving banner information via the network;
(D) processing banner information to obtain a banner image signal displayed on the TV screen, and arranging the position of the banner image signal displayed on the TV screen; and
(E) outputting the size-reduced image signal and the banner image signal to the TV set.

2. The method as claimed in claim 1, wherein the position of the size-reduced image signal displayed on the TV screen is different from the position of the banner image signal displayed on the TV screen.

3. The method as claimed in claim 1, wherein the step (C) further stores the banner information in the set-top box.

4. The method as claimed in claim 3, wherein the step (C), the set-top box retrieves the banner information stored in the set-top box if the set-top box cannot successfully receive the banner information via the network.

5. The method as claimed in claim 4, wherein the banner information stored in the set-top box was previously received by the set-top box.

6. A set-top box used for connecting a network and a TV set to let users browse websites and watch TV from a TV screen, whereby the set-top box can receive at least one image signal and banner information, wherein the image signal is selected from the group consisting of a TV-transmitted image signal, a video-transmitted image signal, or a CD-ROM drive-transmitted image signal, whereby the set-top box can download the banner information through a network, characterized in that the set-top box further comprises:
means for processing the image signal to obtain a size-reduced image signal so that the size-reduced image signal displayed on the TV screen is reduced in size, and positioning the size-reduced image signal displayed on the TV screen;
means for receiving banner information via the network;
means for processing banner information to obtain a banner image signal displayed on the TV screen, and positioning of the banner image signal displayed on the TV screen; and
means for outputting the size-reduced image signal and the banner image signal to the TV set.

7. The set-top box as claimed in claim 6, wherein the position of the size-reduced image signal on the TV screen is different from the position of the banner image signal on the TV screen.

8. The set-top box as claimed in claim 6 further including means for storing banner information in the set-top box.

9. The set-top box as claimed in claim 8 further including means for retrieving banner information stored in the set-top box if the set-top box cannot successfully receive banner information via the network.

10. The set-top box as claimed in claim 9, wherein previously received banner information is stored in the set-top box.
